(19) United States
(12) Patent Application Publication
(10) Pub. No.: US 2015/0212741 A1
(43) Pub. Date: Jul. 30, 2015

(54) APPARATUS FOR IN-MEMORY DATA MANAGEMENT AND METHOD FOR IN-MEMORY DATA MANAGEMENT

(71) Applicant: Electronics and Telecommunications Research Institute, Daejeon (KR)

(72) Inventors: Hun Soon LEE, Daejeon (KR); Mi Young LEE, Daejeon (KR); Chang Soo KIM, Daejeon (KR); Kyoung Hyun PARK, Daejeon (KR); Mai Hai THANH, Daejeon (KR)

(21) Appl. No.: 14/606,916

(22) Filed: Jan. 27, 2015

(30) Foreign Application Priority Data
Jan. 28, 2014 (KR) 10-2014-0010280

(51) Int. Cl. G06F 3/06

(52) U.S. Cl. CPC G06F 3/0613; G06F 3/068; G06F 3/0629

(57) ABSTRACT

Disclosed is an apparatus for in-memory data management includes a hybrid memory including a plurality of types of memories with different characteristics and a storage engine. The storage engine rearranges data among the plurality of memories by the unit of a page by monitoring workloads for data stored in the memories and reconfigures a page layout by the unit of the page based on a data access characteristic of an application for each of pages constituting each of the plurality of memories.

### CROSS-REFERENCE TO RELATED APPLICATIONS

This application claims priority to and the benefit of Korean Patent Application No. 10-2014-0010280 filed in the Korean Intellectual Property Office on Jan. 28, 2014, the entire contents of which are incorporated herein by reference.

### TECHNICAL FIELD

The present invention relates to an apparatus and a method for data management, and more particularly, to an apparatus and a method for managing data on an in-memory including hybrid memories constituted by various memories having different characteristics.

### BACKGROUND ART

A memory area regarded as only an area for a computing operation in the past days, however, the memory area is widely used as a space for storing data as well as the computing operation due to a decline in price of a dynamic random access memory (DRAM). A system that provides all of data management associated functions such as storing data in a main memory, and updating, deleting searching of the stored data, and the like is referred to as an in-memory data management system.

However, when power supplied to the DRAM is shut down, all stored data are disappeared since the DRAM is a volatile memory. Therefore, in order to perform in-memory data management by using the DRAM, although the system is in an idle state in which the system does no task, power should be continuously supplied to the DRAM in order to maintain the data stored in the DRAM. Accordingly, power consumption of the in-memory system using the DRAM is increased due to continuous power supply. Further, the memory space which may be constituted by the DRAM is limited in one system.

As a data service gradually transforms to orient to be based with Cloud, mobile platform, and global networks, transactions which could not be imagined before occur. The newly occurred transactions may include a large amount of data and need to be processed rapidly.

A high-performance computing technology and an in-memory computing technology are required to provide a rapid response time during the data service. However, when the in-memory data management system which uses only the DRAM that is limited in the size of the constitutable memory space is implemented, the in-memory data management system cannot bear all desired data management requirements caused by an application in the age of big data.

### SUMMARY OF THE INVENTION

The present invention relates to an apparatus and a method for in-memory data management that determine characteristics (a frequency of operation performed for data, and the like) of a workload by the unit of a page and rearrange (transfer or move) the page in (to) a memory having a characteristic suitable for the characteristics to improve a total processing throughput of a system and a life-span of a memory device.

The present invention has also been made in an effort to provide an apparatus and a method for in-memory data management that dynamically reconfigure a layout of a page storing data depending on a data access pattern of an application to shorten a response time to an application request.

The objects of the present invention are not limited to the aforementioned objects, and other objects, which are not mentioned above, will be apparent to those skilled in the art from the following description.

An embodiment of the present invention provides an apparatus for in-memory data management includes a hybrid memory including a plurality of types of memories with different characteristics and a storage engine rearranging data among the plurality of memories by the unit of a page by monitoring workloads for data stored in the memories and reconfiguring a page layout by the unit of the page based on a data access characteristic of an application for each of pages constituting each of the plurality of memories. For example, the plurality of types of memories may include volatile memories and non-volatile memories.

The storage engine may include a page access monitor monitoring the access of the application to the page and creating monitoring information, a dynamic data arrangement manager rearranging data by analyzing the workload for the page based on the monitoring information, and a dynamic page layout manager reconfiguring the page layout by the unit of the page to be suitable for a data access characteristic of the application based on the monitoring information.

The dynamic data arrangement manager may include a workload change detecting unit detecting that a change of the workload of the page is equal to or more than a predetermined value based on the monitoring information, a data transference determining unit determining that data is transferred to another memory among the plurality of memories based on the workload for the page of which the workload change occurs, and a data transferring unit transferring the data according to the determined result. For example, the data transference determining unit may determine whether the data is transferred or not by calculating a profit and a loss anticipated when the data is transferred. The data stored in the page where the workload change occurs may transferred to the another memory based on the calculation result. In an embodiment, the workload change detecting unit may calculate the workload based on the number of operations for the page. According to embodiments, the workload change detecting unit may calculate the workload based on the number of operations and given different weights according to the type of the operation.

The dynamic page layout manager may include a workload change detecting unit, a page layout redefining unit, and a page data reconfiguring unit. The workload change detecting unit detects that a time required for processing a data management request for each page is increased by a predetermined value or more based on the monitoring information. The page layout redefining unit redefines the page layout by the unit of the page based on the data access characteristic of the application included in the monitoring information for the page of which the required time is increased by the predetermined value or more. The page data reconfiguring unit reconfigures data of the page of which the required time is increased by the predetermined time or more based on the redefined page layout.

For example, the page layout redefining unit may redefine the page layout based on the data access characteristics of the application and the characteristics of rearranged memories when the data rearrangement is performed simultaneously.

An embodiment of the present invention provides a method for managing a hybrid memory including a plurality of types of memories with different characteristics. The method includes creating monitoring information by monitoring workloads of the plurality of types of memories, rearranging data among the plurality of types of memories based on a workload change for each page included in the monitoring information, and reconfiguring a layout by adjusting column arrangements in the page based on a data access characteristic of an application for each page included in the monitoring information.

The rearranging of the data may include detecting whether a change of the workload is equal to or more than a predetermined value, determining a memory to be transferred based on the number of operations and types of the operations performed for the page of which the change of the workload occurs, and transferring data according to the determined result. In some embodiments, the method may further include determining whether the data is transferred to another memory or not by calculating a profit and a loss anticipated when the data is transferred to the another memory.

The detecting of the workload change may include calculating the workload by giving a weight in accordance with the type of the operation performed for the page.

The reconfiguring of the page layout may include detecting that a time required for processing a data management request for each page is increased by a predetermined value or more based on the monitoring information, redefining the page layout based on the data access characteristic of the application included in the monitoring information for the page, and reconfiguring the data in the page based on the redefined page layout. The redefining the page layout may be performed on the page where the required time is increased by the predetermined value or more.

The redefining of the page layout may include redefining the page layout based on the characteristic of the memory to which the data is to be transferred when the page layout is redefined while the data are rearranged.

According to embodiments of the present invention, a memory space for data management is constituted by mixedly using next-generation memories including a phase change memory, a flash memory, and the like as well as a DRAM, and characteristics of the respective memories are effectively used to extend a capacity limit for a configuration of a storage space for the data management in a single node as compared with constitution of the memory space using only the DRAM.

Compared with a case using only the DRAM, Next-generation memories constituted by low-power memory devices having high energy efficiency are used to save operation and maintenance cost.

By changing an arrangement of memories storing data depending on an access frequency and an access type of an application to data, a total processing throughput of a system and a life-span of the memory device can be increased. A layout of a page storing data is dynamically reconfigured according to a data access pattern of the application, utilization of CPU cache is maximized, and thus a response time to a request from the application is shorten.

An OLTP/OLAP mixed application can be effectively supported at the same time by using one datum which is operated without data duplication(replication) in separating operating data and analysis data. This may be achieved by dynamically arranging data in a hybrid-memory and reconfiguring page layout.

The embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the embodiments of the present invention. It can be easily known that the objects and advantages of the present invention can be implemented by the means and a combination thereof described in the appended claims.

### BRIEF DESCRIPTION OF THE DRAWINGS

FIG. 1 is a diagram illustrating an apparatus for in-memory data management according to an embodiment.

FIG. 2 is a block diagram illustrating an embodiment of a storage engine of the in-memory data management apparatus of FIG. 1.

FIG. 3 is a conceptual diagram for describing a dynamic data arrangement management according to an embodiment of the present invention.

FIG. 4 is a block diagram illustrating an embodiment of a dynamic data arrangement manager of FIG. 2.

FIG. 5 is a diagram for describing an embodiment of a dynamic data arrangement according to the present invention.

FIG. 6 is a block diagram illustrating a dynamic page layout manager according to an embodiment of the present invention.

FIG. 7 is a diagram for describing an embodiment of a dynamic page layout reconfiguration according to the present invention.

FIG. 8 is a diagram for describing a method for storing data in a page after reconfiguring a page layout as described in FIG. 7.

FIG. 9 is a flowchart for describing a method for hybrid in-memory data management according to an embodiment of the present invention.

FIG. 10 is a flowchart illustrating an embodiment of a data rearrangement method of FIG. 9.

FIG. 11 is a flowchart illustrating an embodiment of a page layout reconfiguring method of FIG. 9.

FIG. 12 is a block diagram illustrating a computer system for performing the method for in-memory data management according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the accompanying drawings. Like reference numerals refer to like elements in the drawings and a duplicated description of like elements will be skipped.

Regarding the embodiments of the present invention disclosed in the specification, specific structural or functional descriptions are exemplified to describe the embodiment of the present invention and the embodiments may be carried out in various forms and it should not be analyzed that the present invention is limited to the embodiments described in the specification.

Terms such as first, second, A, B, (a), (b), and the like may be used in describing the components of the embodiments according to the present invention. The terms are only used to distinguish a constituent element from another constituent element, but nature or an order of the constituent element is not limited by the terms.

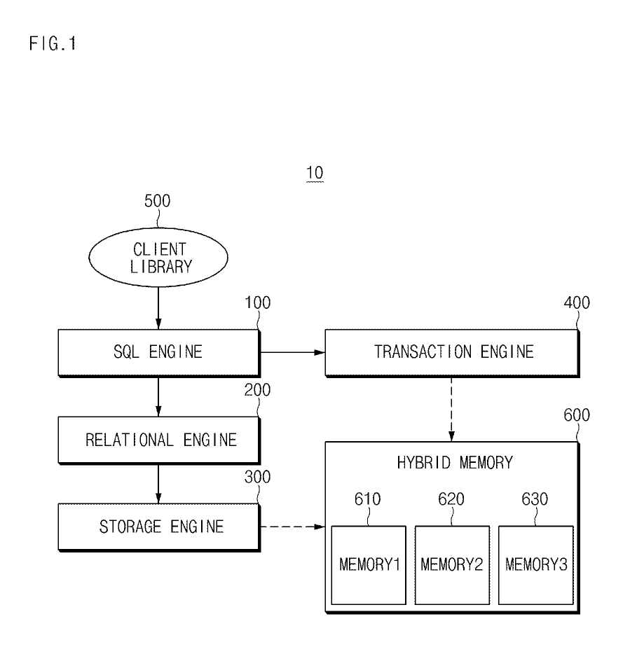

FIG. 1 is a diagram illustrating an apparatus for in-memory data management according to an embodiment.

Referring to FIG. 1, the in-memory data management apparatus 10 may include a structured query language (SQL) engine 100, a relational engine 200, a storage engine 300, a transaction engine 400, a client library 500, and a hybrid memory 600.

The client library 500 interfaces a data management service request from a user to transfer the interfaced request to the SQL engine 100.

The SQL engine 100 processes a SQL statement through processes such as syntax analysis, semantic analysis, optimization and execution control, and the like and the relational engine 200 provides management of a table, an index, and the like which are relational objectives in order to support a relational model.

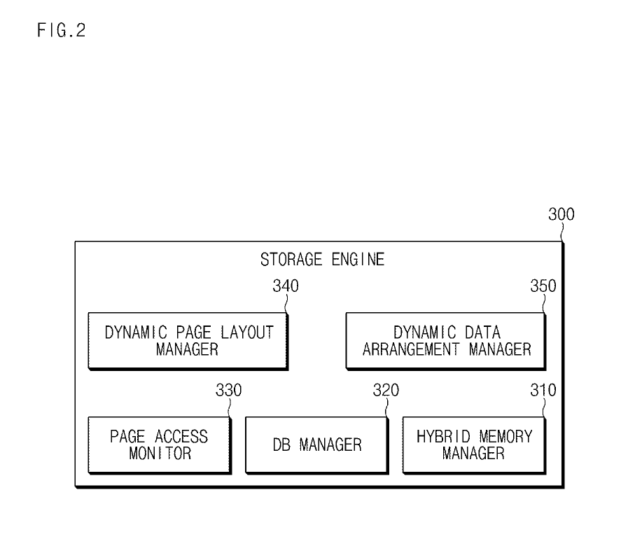

The storage engine 300 performs page level database management, memory allocation, and the like in order to allow data to be stored in and access the hybrid memory 600. The storage engine 300 according to the embodiment of the present invention arranges data in a specific memory of the hybrid memory 600 according to a workload of data and dynamically reconfigures a page layout in memories in the hybrid memory 600. An operation of the storage engine 300 will be described in detail after FIG. 2.

The transaction engine 400 provides concurrency control, log-in, recovery, and the like for supporting a transaction concept.

The in-memory data management apparatus in the related art stores data in a DRAM based memory to allow a plurality of data management applications to access and use data, but data may not be effectively managed on an in-memory by using the hybrid memory including a non-volatile or next-generation memory having a different characteristic from a DRAM.

However, the in-memory data management apparatus 10 according to the embodiment of the present invention is configured to store data in the hybrid memory 600 including various type of memories having different characteristics in order to effectively manage the stored data.

The hybrid memory 600 may include a first memory 610, a second memory 620, and a third memory 630. For example, the respective memories may correspond to the DRAM, a phase change memory, and a flash memory, but this is just exemplary and it may be appreciated that the hybrid memory 600 includes a plurality of types of memories having different characteristics in a data access delay time, whether data is volatile depending on power interruption, cell integrity, and the like.

The respective different types of memories included in the hybrid memory 600 have advantages and disadvantages. For example, the DRAM has a better characteristic than the phase change memory or the flash memory in terms of an access time and update cost. However, DRAM consumes great powers compared with the phase change memory or the flash memory in an idle mode. Since a non-volatile memory such as the flash memory is higher in integrity than the DRAM and the non-volatile is connectable to a PCIe interface in addition to a memory controller, a large-capacity memory may be configured, but an operation (access and update) speed is slower than the DRAM as described above.

In the specification, the description will be made on the assumption that the hybrid memory 600 includes the plurality of types of memories of the DRAM, the phase memory, and the flash memory. However, the present invention is not limited thereto and it is described above that a combination of the hybrid memory constituted by various memories may be applied.

The in-memory data management apparatus 10 according to the embodiment of the present invention appreciates a data access characteristic as well as the characteristic of each memory and uses the characteristics for efficient data management by using the hybrid memory 600. The in-memory data management apparatus 10 performs in-memory data management based on hybrid memory.

The hybrid memory based in-memory data management apparatus 10 according to the present invention places a page having more update operations or a frequently accessed page in a better DRAM than other memories in terms of the access speed and the update cost by monitoring a page access pattern of the application. The hybrid memory based in-memory data management apparatus 10 according to the present invention arranges a page having less update operations in the phase change memory or the flash memory.

The page layout is dynamically changed to a form suitable layout for the page access pattern of the application. In the present invention, dynamically changing the page layout means not continuously storing all columns that belong to one row in a consecutive space but dynamically adjusting the page layout so that columns accessed from the application together are grouped to be positioned in the consecutive space. Therefore, a cache hit ratio may be improved.

The page layout is changed in the storage engine 300 depending on monitoring the data arrangement and the page access pattern in the hybrid memory 600. Hereinafter, the storage engine 300 will be described in detail.

FIG. 2 is a block diagram illustrating an embodiment of a storage engine of the in-memory data management apparatus of FIG. 1.

Referring to FIG. 2, the storage engine 300 may include a hybrid memory manager 310, a database manager 320, a page access monitor 330, a dynamic page layout manager 340, and a dynamic data arrangement manager 350.

The hybrid memory manager 310 manages the memory space of the hybrid memory 600 to access the page during a memory operation.

The hybrid memory manager 310 serves to allocate or de-allocate the memory space by a specific unit (for example, the page) in response to a space request for data storage and a recovery request in other components (for example, the database manager 320, the dynamic data arrangement manager 350, and the like) for the large memory space of the hybrid memory 600.

When the memory space for data storage is requested to the hybrid memory manager 310 from the other components, the memory space is requested by specifying which memory is used among the plurality of types of memories.

The database manager 320 performs data management (insertion, deletion, update, and search) operation by accessing the data of the respective memories of the hybrid memory 600 by the page unit.

The page access monitor 330 monitors the page access of applications for each page. The page access monitor 330 may transfer the collected monitoring information for the page to the dynamic data arrangement manager 350 and the dynamic page layout manager 340 by a predetermined time interval (for example, 1 minute). In some embodiments, the monitoring information collected by the page access monitor 330 may include a frequency for each type of the operation performed for the page, information on a column accessed together for processing a data management request of the user for each page, and a time required to process the data management request for each page.

The dynamic page layout manager 340 reconfigures a page structure having a layout suitable for the workload (access pattern) based on the information collected by the page access monitor 330. In some embodiments, the dynamic page layout manager 340 may determine the workload based on a time required to process a data request for the page.

The dynamic data arrangement manager 350 appreciates a utilization pattern (operation) for the page through analyzing the information collected by the page access monitor 330 to arrange data among different memories in the hybrid memory 600. In some embodiments, the dynamic data arrangement manager 350 may calculate the workload based on the number of access times to the page, that is, the number of times in which various operations are performed, and calculate the workload differently according to an operation type.

According to the present invention, the hybrid memory manager 310 forms the memory space by mixed composition of next-generation memories including the phase change memory and the flash memory as well as the DRAM. Thus, a capacity limit for configuring the storage space for the data management in a single node is extended as compared with constitution of the memory space using only the DRAM.

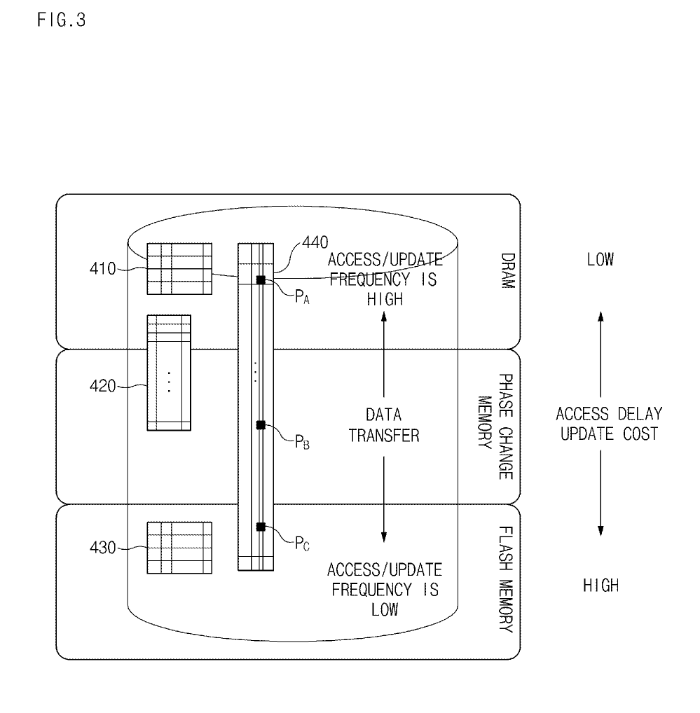

FIG. 3 is a conceptual diagram for describing a dynamic data arrangement management according to an embodiment of the present invention.

Based on the monitoring information collected by the page access monitor 330, the dynamic data arrangement manager 350 according to the embodiment of the present invention arranges data which is high in update operation frequencies or access frequency in a memory having a relatively better characteristic in terms of the access delay time and the update cost (for example, the DRAM), and arranges data which is low in update operation frequencies or access frequency in a memory which is relatively worse in terms of the delay time and the update cost (for example, the flash memory). As a result, a rapid response time may be guaranteed for a data management application in terms of the entire data management apparatus.

The dynamic data arrangement manager 350 may perform an inter-hybrid memory data arrangement by the unit of the page. In some embodiments, all pages constituting one table may be arranged and managed on the same memory 410 and 430, but the pages constituting one table may be scattered and managed on a plurality of hybrid memories 420 and 440.

For example, when page A P_{A}, page B P_{B}, and page C P_{C} constituting the table 440, the page A P_{A} may be arranged in the DRAM, the page B P_{B}, may be arranged in the phase change memory, and the page C P_{C} may be arranged in the flash memory.

When the dynamic data arrangement manager 350 according to the embodiment of the present invention detects the workload for each page to recognize a change in workload which is equal to or more than a predetermined value in respect to a specific page, and then the dynamic data arrangement manager 350 determines whether the page should be arranged in another memory of the hybrid memory 600.

For example, a page which is higher in workload than the other pages may be transferred to a memory which is short in access delay time and a page which is lower in workload than the other pages may be transferred to a memory which is long in access delay time.

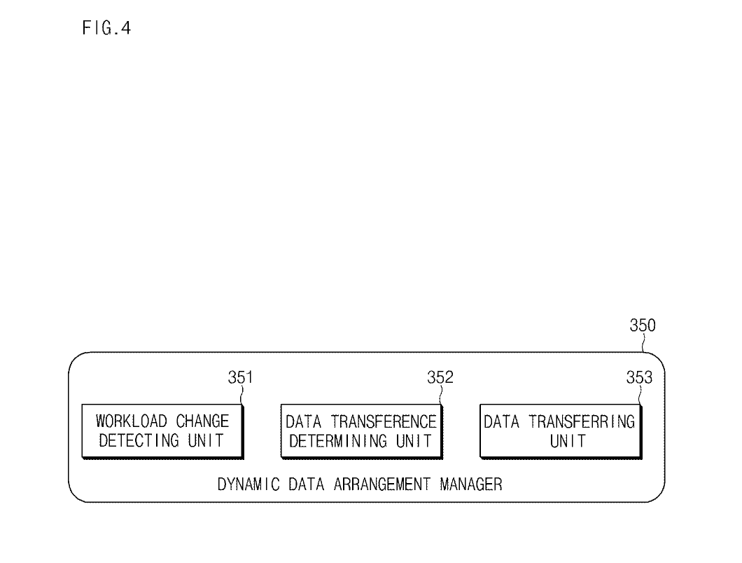

FIG. 4 is a block diagram illustrating an embodiment of a dynamic data arrangement manager of FIG. 2.

Referring to FIG. 4, the dynamic data arrangement manager 350 may include a workload change detecting unit 351, a data transference determining unit 352, and a data transferring unit 353.

The workload change detecting unit 351 analyzes the workload based on the monitoring information received from the page access monitor 330 to determine whether a workload of a specific page is changed by a predetermined value or more.

The data transference determining unit 352 determines whether it is appropriate which memory among the memories constituting the hybrid memory 600 for pages of which the workload change is detected by the predetermined value or more transfer to.

The data transferring unit 353 transfers data among hybrid memories having different characteristics according to the determined result of the data transference determining unit 352.

The workload change detecting unit 351 of the dynamic data arrangement manager 350 according to the embodiment of the present invention may detect the workload change for the dynamic data arrangement based on a change in access frequency to the page.

In calculating the workload, in some embodiments, a search operation and an update operation may be handled in a similar manner and a higher weight is given to the update operation than the search operation to calculate the workload or vice versa.

When the higher weight is given to the update operation at the time of calculating the workload, a page in which the update operation is frequent may be arranged in the DRAM as compared with a memory in which a delay time difference between read and write operations is large or is limited in the number of write times, such as the phase change memory or the flash memory. A processing throughput for an overall data management request may be increased through dynamic data rearrangement based on the workload and the life-span of the in-memory data management apparatus may be increased.

In the embodiment, the data transference determining unit 352 may determine the data transference based on profit and loss calculation depending on the data transference. For example, the data transference determining unit 352 may transfer only in the case where a profit is anticipated when the data transfers to another memory in the hybrid memory 600 by considering cost for data management and management operation supporting, cost required for transferring data, and the like.

In some embodiments, when the data transferring unit 353 transfers data among the memories, the data transferring unit 353 may change the layout of the page to a form of the page layout optimized for the workload at the transferring time of the page and transfer the corresponding data in cooperation with the dynamic page layout manager 340.

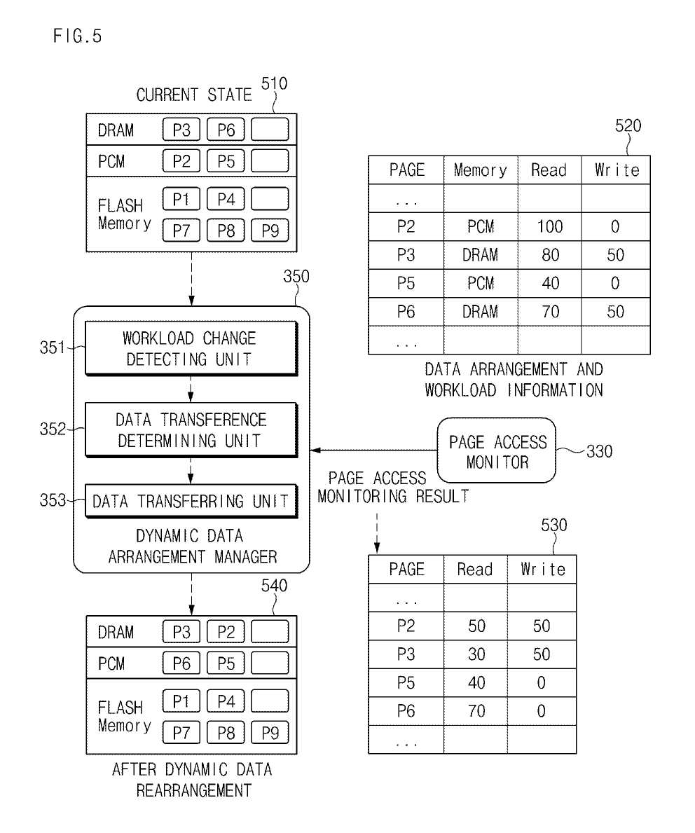

FIG. 5 is a diagram for describing an embodiment of a dynamic data arrangement according to the present invention.

In FIG. 5, it is assumed that the hybrid memory 600 is constituted by the different memories of the DRAM, the phase change memory, and the flash memory. The respective memories have capacities capable of accommodating 3, 3, and 6 pages, respectively.

Referring to reference numeral 510 of FIG. 5, at present, a third page P3 and a sixth page P6 are arranged in the DRAM, a second page P2 and a fifth page P5 are arranged in the phase change memory, and a first page P1, a fourth page, P4, and seventh to ninth pages P7, P8, and P9 are arranged in the flash memory.

In such a current-state data arrangement, workload information is represented by reference numeral 520. In the embodiment described with reference to FIG. 5, it is assumed that the write operation has a workload having a weight which is twice greater than the read operation.

The page access monitor 330 collects new page access monitoring information 530, and transfers the page access monitoring information 530 to the dynamic data arrangement manager 340 after a predetermined time elapsed in a current state. In this case, the workload change detecting unit 351 of the dynamic data arrangement manager 350 detects a change of a workload which is more than a predetermined value (for example, 25%) in the second page P2, the third page P3, and the sixth page P6.

The data transference determining unit 352 calculates a profit and a loss anticipated when the data is transferred among the hybrid memories (the DRAM, the phase change memory, and the flash memory) and determines whether to transfer the data stored in page and where the transferring data to be transferred based on the calculated profit and loss.

The data transference determining unit 352 may determine that it is appropriate that the second page P2 in which the update operation is significantly increased is transferred to the DRAM, the sixth page P6 in which the access frequency is significantly decreased is transferred to the phase change memory, and the third page P3 in which the total access frequency is decreased, but the update operation is a lot is just arranged in the DRAM.

The data transferring unit 353 transfers the second page P2 to the DRAM and the sixth page P6 to the phase change memory based on the determined result of the data transference determining unit 352. Newly arranged data may be represented by reference numeral 540.

The in-memory data management apparatus 10 according to the embodiment of the present invention may dynamically reconfigure the page layout in the form suitable for the workload based on the monitoring information collected by the page access monitor 330 as well as rearranging data among the hybrid memories.

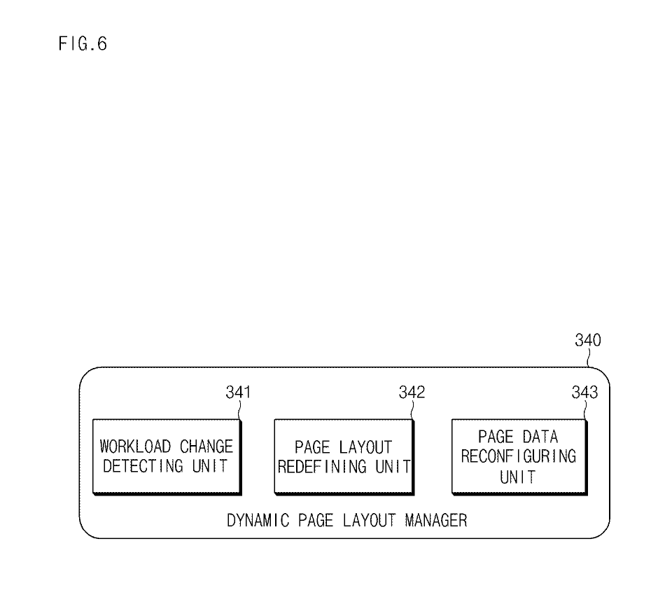

FIG. 6 is a block diagram illustrating a dynamic page layout manager according to an embodiment of the present invention.

The dynamic page layout manager 340 reconfigures the page layout in a manner of differentiating configurations of columns stored in an adjacent space of the memory according to the data access pattern of the application.

The dynamic page layout manager 340 determines and store an average time required for processing the data management request for the corresponding page in a current page layout. Thereafter, the time required for processing the data management request for each page, which is received from the page access monitor 330 and the stored time are compared with each other to reconfigure the page layout for a page of which the difference increases by the predetermined value (for example, 25%) or more.

Referring to FIG. 6, the dynamic page layout manager 340 may include a workload change detecting unit 341, a page layout redefining unit 342, and a page data reconfiguring unit 343.

The workload change detecting unit 341 analyzes monitoring information for the time required for processing the data management request for each page, which is received from the page access monitor 330 to detect the workload change by considering whether the processing time is changed by the predetermined value or more.

The page layout defining unit 342 redefines the page layout in a form suitable for the current workload in regards with the page of which the workload change is detected. The page layout defining unit 342 redefines the page layout based on column access information corresponding to a data access characteristic of the application for each page received from the page access monitor 330, and the characteristic of the memory.

The page data reconfiguring unit 343 reconfigures page data based on the page layout defined by the page layout redefining unit 342.

The page layout may be configured differently for each page in the dynamic page layout reconfiguration by the dynamic page layout manager 340 according to the present invention. Accordingly, all pages constituting one data table managed by the system according to the present invention may have the same page layout, but may have different page layouts.

Column data accessed together are stored in the consecutive space so that a data management request of the user for the corresponding page is rapidly processed through the dynamic page layout reconfiguration, and as a result, CPU cache efficiency may be maximized by reducing a possibility of CPU cache miss. This may provide a rapid response time to a data management application in terms of the entire system.

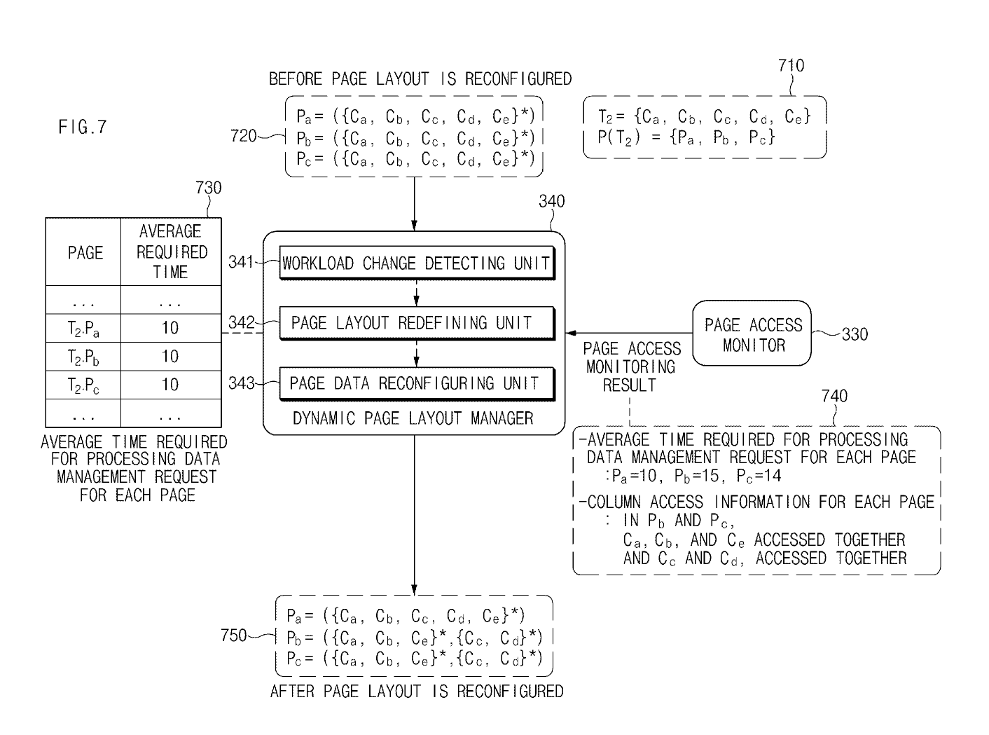

FIG. 7 is a diagram for describing an embodiment of a dynamic page layout reconfiguration according to the present invention.

In FIG. 7, it will be described that each of 3 pages Pₐ, P_{b}, and P_{c} constituting a table T₂ includes 5 columns Cₐ, C_{b}, C_{c}, C_{d}, and C_{c} as an example (710).

All columns are stored in the consecutive space in the respective pages Pₐ, P_{b}, and P_{c} (720) and it is assumed that the predetermined value is 25% of the previous workload in order for the workload change detecting unit 341 to reconfigure the page layout.

It is assumed that an average time required for processing a first data management request after configuring the current page layout is 10 in all of 3 pages of the table T₂ (730).

As a result of the page access monitor 330's monitoring the pages Pₐ, P_{b}, and P_{c} constituting the table T₂, the time required for processing the data management request for each page is 10, 15, and 14 for the pages Pₐ, P_{b}, and P_{c}, respectively.

According to the column access information which is the data access characteristic of the application for each page, it is determined that in the application that accesses column C_{c} in respect to the pages P_{b} and P_{c}, in a lot of cases, there is a tendency of which column C_{d} is together accessed and in an application that accesses column Cₐ, in a lot of cases, there is a tendency of which columns C_{b} and C_{c} are together accessed (740).

The workload change detecting unit 341 of the dynamic page layout manager 340 compares the average time (730) required for processing the data management request for each page previously stored and the monitoring information (740) from the page access monitor 330. The workload change detecting unit 341 detects that the average time required for processing the data management request in regards to the page P_{b} and the page P_{c} is increased by 25% or more.

The page layout redefining unit 342 redefines the page layout of the page P_{b} and page P_{c} so that data corresponding to the columns Cₐ, C_{b}, and C_{c} are arranged in an adjacent space ({Cₐ, C_{b}, and C_{c}}) and data corresponding to the columns C_{c} and C_{d} are arranged in a consecutive space ({C_{c} and C_{d}}) based on the access information for each page.

The page data reconfiguring unit 343 dynamically reconfigures page data based on redefined page layout created by the page layout redefining unit 342 (750).

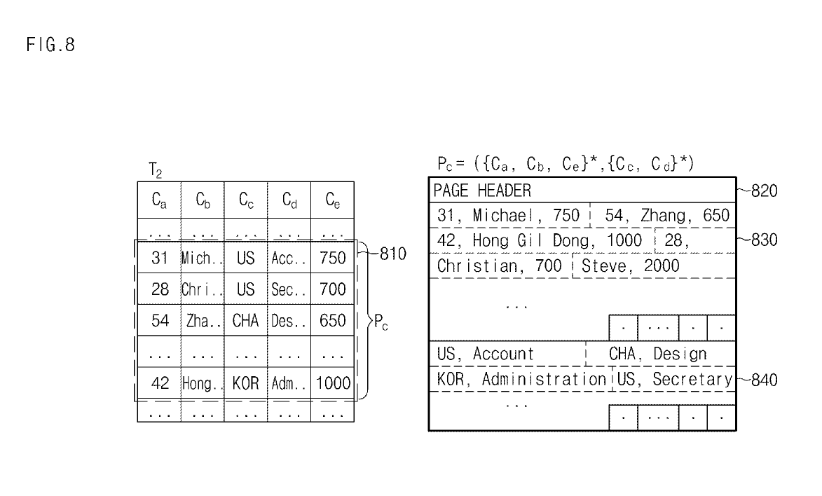

FIG. 8 is a diagram for describing a method for storing data in a page P_{c} after reconfiguring a page layout as described in FIG. 7.

In FIG. 8, there are data 810 that belong to the page P_{c} included in data constituting the table T₂.

Actually, data of the page P_{c} is stored in a form illustrated at the right side by the page data reconfiguring unit 343 according to the information of the redefined page layout created by the page layout redefining unit 342.

A page header 820 of page P_{c} is positioned. Row data corresponding to the columns Cₐ, C_{b}, and C_{c} are stored in the consecutive space (830), and row data corresponding to the columns C_{c} and C_{d} are stored in the consecutive space (840).

According to the present invention, the dynamic page layout reconfiguration may occur even in the case where the memory storing the data is changed by the dynamic data arrangement performed by the dynamic data arrangement manager 350 as well as in the same memory.

In the case where the memory storing the data is changed, the page layout may be reconfigured and the data is stored based on the reconfigured page layout. The page layout may be reconfigured in a form optimized for the characteristic of the memory by considering the characteristic of the memory in which the data is transferred and stored as well as the monitoring information of the page access monitor 330.

In order to support an online transaction processing (OLTP) application and an online analytical processing (OLAP) application, operating data for OLTP and analysis data of OLAP are separated and the data are periodically replicated and serviced in the related art. However, according to the present invention, data processing may be simultaneously and efficiently supported with one operating datum.

For example, in the case of bank transaction associated data, both OLTP and OLAP characterized applications generally access data during a predetermined period in recent years, but only the OLAP characterized application unusually accesses old data. Accordingly, recent bank transaction data of which access and update frequencies are relatively high are arranged and managed in the DRAM and old transaction history data which are rarely requested to be updated are arranged and managed in the non-volatile memory to effectively use the in-memory management apparatus including the hybrid memory.

According to the present invention, by considering the characteristic of the OLAP application at the time of transferring the data to the non-volatile memory, the page layout may be dynamically reconfigured so as to provide the page layout suitable for the OLAP application, which is different from that when the data are arranged in the DRAM.

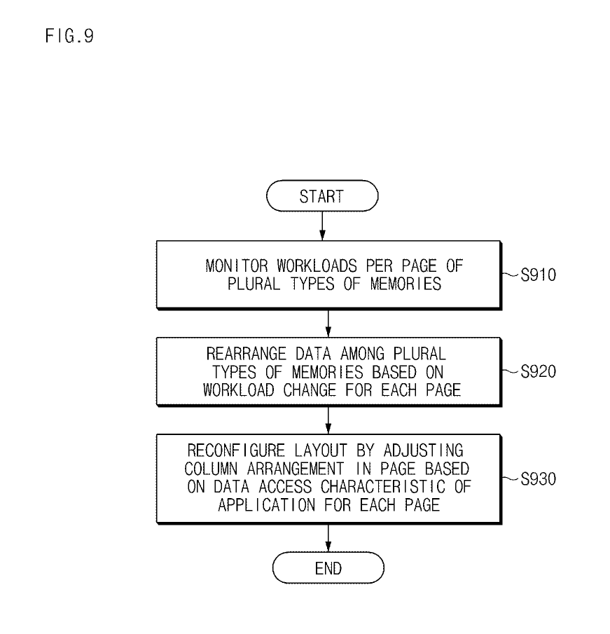

FIG. 9 is a flowchart for describing a method for hybrid in-memory data management according to an embodiment of the present invention.

Referring to FIG. 9, the page access monitor 330 included in the storage engine 300 monitors page-unit access characteristics of different types of memories (refer to the first memory 610 to the third memory 630 of FIG. 1) to create monitoring information (step S910).

The dynamic data arrangement manager 350 receives the monitoring information at a predetermined time interval to rearrange data of a page of which the workload is changed in another memory based on the workload change for each page (step S920).

The dynamic page layout manager 340 also receives the monitoring information at the predetermined time interval and adjusts column arrangement in the page based on the data access characteristic of the application for each page included in the monitoring information to reconfigure a layout (step S930).

In some embodiments, when the time required for processing the data management request for the page increases by a predetermined value or more, the workload for the page, that is, the workload calculated according to the number of operation times and the operation type may also increase by the predetermined value or more. In this case, data rearrangement and page layout reconfiguration may be simultaneously performed. The dynamic page layout manager 340 may reconfigure the page layout based on a characteristic of a memory in which data is to be rearranged as well as a column-unit data access characteristic.

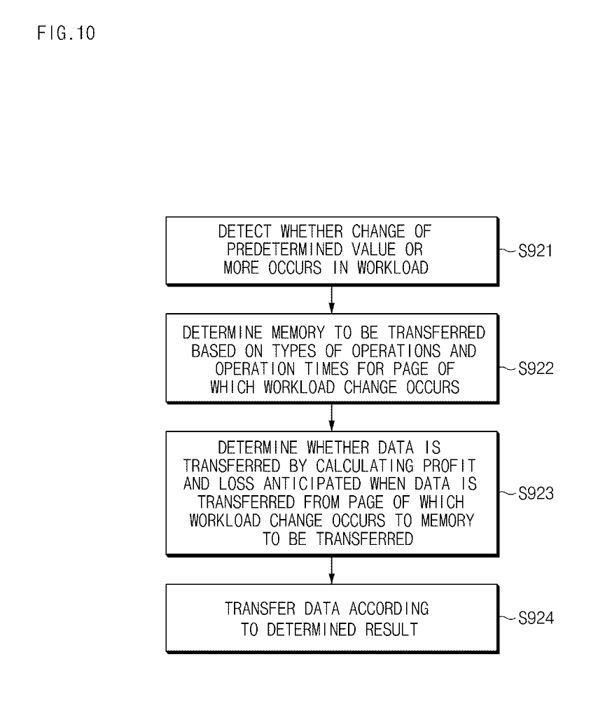

FIG. 10 is a flowchart illustrating an embodiment of a data rearrangement method of FIG. 9.

Referring to FIG. 10, the workload change detecting unit 351 detects that the workload is changed by a predetermined value or more (step S931). The dynamic data arrangement manager 350 may receive the monitoring information from the page access monitor 330 at a predetermined time interval to thereby determine the types of the operations and the number of times of the operations performed for the page.

In some embodiments, all pages may be handled to acquire an equivalent workload according to the operation type while calculating the workload, but the workload may be calculated with different weights according to the operation type.

The data transference determining unit 352 determines a memory to which data is to be transferred based on the types of the operations and the number of times of the operations performed for the page of which the workload is changed by a predetermined value (step S922). For example, even though an access frequency is the same similarly as calculating the workload, a page in which a lot of update operations are frequently performed may be arranged in the volatile memory such as the DRAM and a page where a lot of simple search operations are performed may be arranged in the non-volatile memory such as the flash memory.

In some embodiments, the data transference determining unit 352 calculates a profit anticipated when data is transferred to the memory to which data is to be transferred from the page of which the workload is changed to determine whether transfer the data or not (step S923). When a loss occurs by transferring the data, the data need not be transferred.

The data transferring unit 353 transfers the data based on the determined result (step S924).

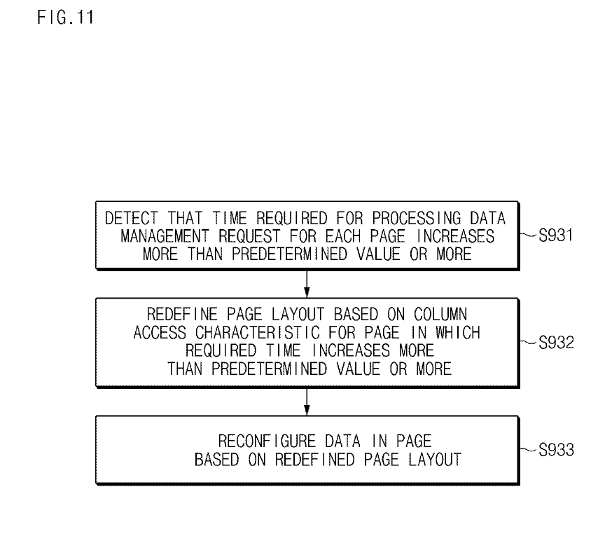

FIG. 11 is a flowchart illustrating an embodiment of a page layout reconfiguring method of FIG. 9.

Referring to FIG. 11, the workload change detecting unit 341 detects that the time required for processing the data management request for each page increases by the predetermined value or more (step S931).

The page layout redefining unit 342 extracts from the monitoring information the column access information which is the data access characteristic of the application for the page of which the required time increases by the predetermined value or more to redefine the page layout (step S932).

The page data reconfiguring unit 343 reconfigures the data in the page based on the reconfigured page layout (step S933). In detail, the layout is reconfigured so that columns having a high tendency of simultaneously accessed are positioned at adjacent portions in one page. Data access efficiency is improved by reconfiguring the layout to reduce the time required for processing the data request.

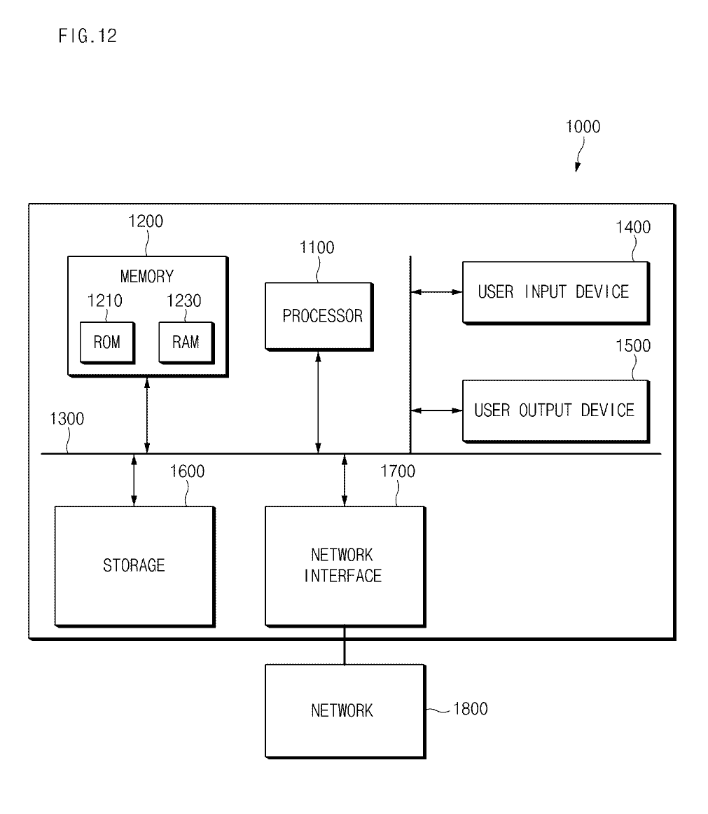

FIG. 12 is a block diagram illustrating a computer system for performing the method for in-memory data management according to the present invention. In addition, the computer system illustrated in FIG. 12 also includes the apparatus for in-memory data management according to the present invention.

An embodiment of the present invention may be implemented in a computer system, e.g., as a computer readable medium. As shown in in FIG. 12, a computer system 1000 may include one or more of a processor 1100, a memory 1200, a user input device 1400, a user output device 1500, and a storage 1600, each of which communicates through a bus 1300. The computer system 1000 may also include a network interface 1700 that is coupled to a network 1800. The processor 1100 may be a central processing unit (CPU) or a semiconductor device that executes processing instructions stored in the memory 1200 and/or the storage 1600. The memory 1200 and the storage 1600 may include various forms of volatile and non-volatile storage media. For example, the memory may include a read-only memory (ROM) 1210 and a random access memory (RAM) 1230. The user input device 1400 and the user output device 1500 may perform interfacing operation for receiving user instructions or outputting message of the system to a user.

Accordingly, an embodiment of the present invention may be implemented as a computer implemented method or as a non-transitory computer readable medium with computer executable instructions stored thereon. In an embodiment, when executed by the processor, the computer readable instructions may perform a method according to at least one aspect of the invention.

Although the present invention described as above is not limited by the aforementioned embodiments and the accompanying drawings and it will be apparent to those skilled in the art that various substitutions, modifications, and changes can be made within the scope without departing from the technical spirit of the present invention.

What is claimed is:

1. An apparatus for in-memory data management, the apparatus comprising:
a hybrid memory including a plurality of types of memories with different characteristics; and
a storage engine configured to rearrange data in the plurality of memories by the unit of a page by monitoring workloads for the data stored in the memories and reconfigure a page layout by the unit of the page based on a data access characteristic of an application for each of pages constituting each of the plurality of memories.

2. The apparatus of claim 1, wherein the storage engine includes:
a page access monitor configured to monitor an access of the application to the page and create monitoring information;
a dynamic data arrangement manager configured to rearrange the data by analyzing the workload for the page based on the monitoring information; and
a dynamic page layout manager configured to reconfigure the page layout by the unit of the page to be suitable for the data access characteristic of the application based on the monitoring information.

3. The apparatus of claim 2, wherein the dynamic data arrangement manager includes:
a workload change detecting unit configured to detect that a change of the workload of the page is a predetermined value or more based on the monitoring information;
a data transference determining unit configured to determine that data is transferred to another memory among the plurality of memories based on the workload for the page of which the workload change occurs; and
a data transferring unit configured to transfer the data according to the determined result.

4. The apparatus of claim 3, wherein the data transference determining unit determines whether the data is transferred by calculating a profit and a loss anticipated when the data is transferred from the page of which the workload change occurs.

5. The apparatus of claim 3, wherein the workload change detecting unit calculates the workload based on the number of operations for the page.

6. The apparatus of claim 5, wherein the workload change detecting unit gives a weight for each of types of operation including write and read to calculate the workload.

7. The apparatus of claim 2, wherein the dynamic page layout manager includes:
a workload change detecting unit configured to detect that a time required for processing a data management request for each page is increased by a predetermined value or more based on the monitoring information;
a page layout redefining unit configured to redefine the page layout by the unit of the page based on the data access characteristic of the application for the page of which the required time is increased by the predetermined value or more, the data access characteristic being included in the monitoring information; and
a page data reconfiguring unit configured to reconfigure data of the page of which the required time is increased by the predetermined time or more based on the redefined page layout.

8. The apparatus of claim 7, wherein the page layout redefining unit redefines the page layout based on characteristics of rearranged memories when the data rearrangement is performed.

9. The apparatus of claim 1, wherein the plurality of types of memories includes volatile memories and non-volatile memories.

10. A method for managing a hybrid memory including a plurality of types of memories with different characteristics, the method comprising:
creating monitoring information by monitoring workloads of the plurality of types of memories;
rearranging data among the plurality of types of memories based on a workload change for each page based on the monitoring information; and
reconfiguring a layout by adjusting column arrangements in the page based on a data access characteristic of an application for each page based on the monitoring information.

11. The method of claim 10, wherein the rearranging of the data includes:
detecting whether a change of a predetermined value or more occurs in the workload;
determining a memory to be transferred based on the number of operations and types of the operations performed for the page of which the workload change of the predetermined value or more occurs; and
transferring data according to the determined result.

12. The method of claim 11, further comprising:
determining whether the data is transferred by calculating a profit and a loss anticipated when the data is transferred from the page of which the workload change occurs to the memory to which the data is to be transferred.

13. The method of claim 11, wherein the detecting of the workload change includes calculating the workload by giving a weight in accordance with the type of the operation performed for the page.

14. The method of claim 10, wherein the reconfiguring of the page layout includes:
detecting that a time required for processing a data management request for each page is increased by a predetermined value or more based on the monitoring information;
redefining the page layout based on the data access characteristic of the application for the page of which the required time is increased by the predetermined value or more based on the monitoring information; and
reconfiguring the data in the page based on the redefined page layout.

15. The method of claim 14, wherein the redefining of the page layout include redefining the page layout based on the characteristic of the memory to which the data is to be transferred when the page layout is redefined while the data are rearranged.
